(19) United States
(12) Patent Application Publication
(10) Pub. No.: US 2026/0261159 A1
(43) Pub. Date: Sep. 3, 2026

(54) Systems and Methods for Additive Production of a Magnetic Plate, a Laminated Core, and an Electric Machine

(71) Applicant: Siemens Aktiengesellschaft, München (DE)

(72) Inventors: Carsten Schuh, Baldham (DE); Rolf Vollmer, Gersfeld (DE)

(73) Assignee: Siemens Aktiengesellschaft, München (DE)

(21) Appl. No.: 18/858,429

(22) PCT Filed: Apr. 19, 2023
(86) PCT No.: PCT/EP2023/060129

§ 371 Date: Oct. 21, 2024

(30) Foreign Application Priority Data
Apr. 27, 2022 (EP) 22170312.7
May 31, 2022 (EP) 22176511.8

(51) Int. Cl. H02K 1/02; B33Y 80/00; C22C 38/40; H01F 1/16; H02K 1/278; H02K 21/14

(52) U.S. Cl. CPC H02K 1/02; B33Y 80/00; C22C 38/40; H01F 1/16; H02K 1/278; H02K 21/14; C22C 2202/02

(57) ABSTRACT

Various embodiments of the teachings herein include additively produced magnetic sheet for a laminated core of an electric machine. An example includes: a first material component arranged in a radially inner area of the magnetic sheet; a second material component arranged in a radially outer area; and a transition area between the radially inner area and the radially outer area, wherein the transition area includes both the first material component and the second material component in discrete sub-areas. The discrete sub-areas are arranged in a row in the radial direction such that a line following a radius cuts at least two discrete sub-areas.

### CROSS-REFERENCE TO RELATED APPLICATIONS

This application is a U.S. National Stage Application of International Application No. PCT/EP2023/060129 filed Apr. 19, 2023, which designates the United States of America, and claims priority to EP Application No. 22176511.8 filed May 31, 2022, and EP Application No. 22170312.7 filed Apr. 27, 2022, the contents of which are hereby incorporated by reference in their entirety.

### TECHNICAL FIELD

The present disclosure relates to additive production. Various embodiments of the teachings herein include systems and/or methods for additive production of a magnetic sheet, parts of a laminated core, and parts of an electric machine.

### BACKGROUND

Screen or stencil printing may be used for producing magnetic sheets for electric machines. A printing paste is printed onto a substrate by means of a stencil in which the open areas can also be provided with a screen. This is referred to as stencil printing or screen printing, with stencil printing being a generic term for screen printing. In addition to solvents and/or binders, the printing paste contains metal powders which act functionally in the later component. The screen printing technique produces a green body which, after a further thermal treatment, is first of all debonded, as a rule, and is subsequently fed to a sintering process at a higher temperature, with the metallic powder grains sintering together in such a way that a structured metal sheet, the magnetic sheet, is produced.

In order to achieve a higher mechanical strength of such metal sheets, in particular at high rotational speeds of rotors of electric machines, the ability to produce two-component magnetic sheets is becoming increasingly important. An example of this is described in EP 3723249 A1. Furthermore, EP 3 629 453 A1, EP 3 932 591 A1 and EP 3 725 435 A1 should also be mentioned here. A fundamental problem with such two-component magnetic sheets produced in the stencil printing method is that the different materials, if they have good magnetic properties on the one hand and have a high strength on the other hand, have, as a rule, different coefficients of thermal expansion. Thus, for example, a high-strength steel, which represents a partial component for the mechanical strength of the magnetic sheet, has a coefficient of expansion of 16×10⁻⁶ K⁻¹. In this case, a further soft-magnetic material in a temperature range between 0 and 100° C. has a coefficient of thermal expansion which lies between 10-12×10⁻⁶ K⁻¹. During the joint sintering of such different material components or material pairings in a green body to form a magnetic sheet, high mechanical stresses form in the connecting or seam areas between these material components, in particular when cooled from the sintering temperatures to room temperature, owing to these different coefficients of thermal expansion. This can lead to curvatures or to cracks or overall to mechanical stresses in the magnetic sheet, which can significantly impair the mechanical or magnetic properties.

### SUMMARY

The teachings of the present disclosure include methods and systems to produce a magnetic sheet and generate a laminated core and an electric machine therefrom in which the magnetic sheet may have a higher strength and less intrinsic stresses compared to the prior art when using at least two material components within the magnetic sheet. For example, some embodiments of the teachings herein include an additively produced magnetic sheet (2) for a laminated core (4) of an electric machine (6), wherein at least two material components (8, 10) separated from one another in a planar extension are present, characterized in that a first material component (8) is arranged in a radially inner area (12) of the magnetic sheet (2) and a second material component (10) is arranged in a radially outer area (14), and a transition area (16) is provided between the radially inner area (12) and the radially outer area (14), in which both the first material component (8) and the second material component (10) are present in discrete sub-areas (18), wherein the discrete sub-areas (18) are arranged in a row in the radial direction (20) such that a line (22) that follows the radius cuts at least two discrete sub-areas (18).

In some embodiments, in a boundary area (24) between the first material component (8) and the second material component (10) a diffusion zone is present in the transition area (16), and this extends by at least 50 μm into the respective other material component (8, 10).

In some embodiments, in the transition area (16) a surface proportion of the first material component (8) is between 5% and 40%.

In some embodiments, the transition area (16) has a radial extension (28) which is between 1 mm and 30 mm.

In some embodiments, the discrete areas have a maximum extension which is between 0.5 mm and 10 mm.

In some embodiments, the transition area (16) has a radial extension (28) which is between 3 mm and 10 mm.

In some embodiments, a plurality of discrete sub-areas (18) of at least one material component (8, 10) intersect in such a way that consequently at least one discrete sub-area (18′) of the respective other material component (8, 10) is enclosed.

In some embodiments, the first material component (8) comprises an iron alloy, at least 25% by volume of which has an austenitic structure.

In some embodiments, the second material component (10) comprises an iron alloy which comprises at least 95% by weight, in particular at least 97% by weight, iron.

In some embodiments, the second material component (10) has a ferritic or martensitic structure.

In some embodiments, the first material component (8) is a chromium-nickel alloy.

In some embodiments, the first material component (8) is an iron-chromium alloy with a chromium content which is between 22% by weight and 28% by weight, in particular between 24% by weight and 26% by weight.

In some embodiments, the first material component (8) has a nickel content which is between 4% by weight and 10% by weight, in particular between 6% by weight and 8% by weight.

As another example, some embodiments include a laminated core for a rotor (30) of an electric machine (6) comprising a plurality of magnetic sheets (2) as described herein.

As another example, some embodiments include an electric machine comprising a laminated core (4) as described herein.

### BRIEF DESCRIPTION OF THE DRAWINGS

Further embodiments of the teachings herein and further features can be found in the following figures. These are purely schematic forms of representation which do not limit the scope of the disclosure. In the drawings:

FIG. 1 shows an exploded representation of an electric machine in the form of an electric motor incorporating teachings of the present disclosure;

FIG. 2 shows a laminated core for a rotor incorporating teachings of the present disclosure;

FIG. 3 shows a plan view of a magnetic sheet with different areas of material incorporating teachings of the present disclosure;

FIG. 4 shows an enlarged detail of FIG. 3 in the area of a transition area between two material components;

FIG. 5 shows an enlarged representation of the transition area in FIG. 4;

FIGS. 6 to 10 show different embodiments of discrete areas in the transition area incorporating teachings of the present disclosure; and

FIG. 11 shows an enlarged representation of the detail XII in FIGS. 6, 7, 9 in which a boundary area with a diffusion zone is represented.

### DETAILED DESCRIPTION

Some embodiments of the teachings herein include an additively produced magnetic sheet for a laminated core of an electric machine, wherein at least two material components separated from one another in a planar extension are present, characterized in that a first material component is arranged in a radially inner area of the magnetic sheet and a second material component is arranged in a radially outer area, and a transition area is provided between the radially inner area and the radially outer area, in which both the first material component and the second material component are present in discrete sub-areas, wherein the discrete sub-areas are arranged in a row in the radial direction such that a line that follows the radius cuts at least two discrete sub-areas.

Due to a local material design, on the one hand areas of material with very good magnetic properties can be locally represented and, on the other hand, areas of material with very high mechanical strengths can be represented. Both material components are present in the form of discrete sub-areas in the transition area(s). The discrete sub-areas are arranged along a line that follows the radius such that this line cuts at least two sub-areas. This means that the sub-areas repeat themselves in the radial direction and their effect is intensified and the connection of the two material components to each other is improved. The transition area with the respectively described discrete sub-areas of the individual material components is particularly suitable for adapting the different thermal coefficients of expansion to each other. In the case of the described discrete sub-areas, which are smaller in their two-dimensional extension, the absolute expansion is smaller in its own right when heated during operation or also in the case of sinter shrinkage, than in the larger areas, namely the radially inner and radially outer areas. By way of calculation, for example with finite elements, it is possible to ascertain a suitable structure of the discrete sub-areas in the transition area and thus the stresses within the magnetic sheet can also still be minimized by application of the described finite element method.

In addition, a longer boundary line, which occurs alternately in different directions, as is caused by the discrete sub-areas, counteracts mechanical stresses owing to different thermal coefficients of expansion.

Discrete sub-areas should in this case be taken to mean that there is no mixing of the individual material components in the transition area. Instead, areas with the first material component and the second material component are present separately from each other in the transition area, i.e. are discrete in certain sections. The discrete areas can therefore be embodied by the first material component and by the second material component. These can be present side by side in the transition area. A discrete area can be directly connected to the respective area of material that corresponds to it, i.e. the inner or the outer area. That is to say, the discrete area with one material component grows out of its corresponding area and into the second material component, although it is present discretely with respect to the second material component.

The individual material components in the transition area can be arranged both continuously at the inner or outer area or be present as islands inside the respective other material component. The transition area with the respectively described discrete sub-areas of the individual material components is particularly suitable for adjusting the different thermal coefficients of expansion to each other. In the case of the described smaller discrete sub-areas, the absolute expansion when warmed during operation or also with sinter shrinkage is smaller in its own right than in the case of larger areas. By way of calculation, for example with finite elements, it is possible to ascertain a suitable structure of the discrete sub-areas in the transition area and thus the stresses within the magnetic sheet are also still minimized by application of the described finite element method.

In particular in the case of representation of island-like discrete sub-areas in the transition printing areas, it can be laborious in terms of process engineering for a material component to be printed into a material component which has already been printed. In this case it can be expedient to use a printing-free additive manufacturing method, in particular a spraying method, for the representation of the second printed material pre-component, in particular in the island areas.

In some embodiments, the magnetic sheet is embodied such that in a boundary area between the first material component and the second material component, a diffusion zone is present in the transition area which extends by at least 50 μm into the respective other material component. This purposefully introduced diffusion zone is wider than diffusion zones which are conventionally present with a co-sintering process of two different material components. The wider diffusion zone brings about a further alignment of the different coefficients of expansion.

In some embodiments, a surface proportion of the first material component in the transition region is between 5% and 40%. The thermally induced tensions may be effectively reduced by way of the ratio between first material component and second material component in the transition area.

Depending on the expansion of the magnetic sheet and thus depending on the diameter of a laminated core and rotor of an electric machine, in some embodiments, the transition area has a radial extension which is between 1 mm and 30 mm. In some embodiments, the transition area has a radial extension which is between 3 mm and 10 mm along a radius of the magnetic sheet. The discrete areas have a maximum extension in this case which is between 0.5 mm and 10 mm. A maximum extension is taken to mean the maximum straight line which can be drawn in the discrete area without leaving it.

In some embodiments, a plurality of discrete sub-areas of at least one material component intersect in such a way that consequently at least one discrete sub-area of the respective other material component is enclosed. A fence-like structure of this kind is particularly suitable for producing interconnections between the individual material components and minimizing the effect of the different coefficients of expansion in the process.

In some embodiments, the second material component is an iron alloy which has at least 95% by weight, in particular at least 97% by weight, or 99% by weight, iron. In some embodiments, this is pure iron since pure iron has the best ferritic structure or martensitic structure and has very good soft-magnetic properties which are advantageous for the respective reversal of magnetization in an electric machine.

The first material component in the radially inner area of the magnetic sheet may be embodied such that it has an optimally high strength and withstands the mechanical load, which acts on the magnetic sheet. In particular a chromium-nickel alloy is expedient for this as the starting material for the first material component. This chromium-nickel alloy may have a chromium content which is between 22% by weight and 28% by weight, in particular between 24% by weight and 26% by weight.

In some embodiments, the nickel content is between 4% by weight and 10% by weight, in particular between 6% by weight and 8% by weight, with the basic values each being incorporated in the stated range.

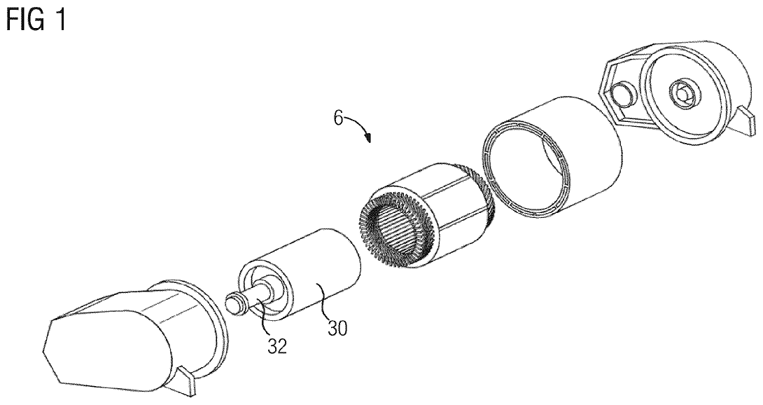

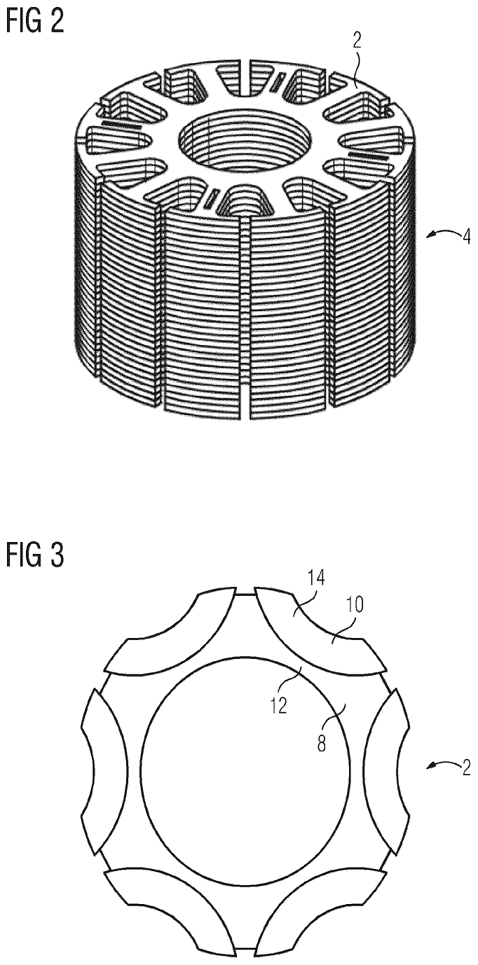

FIG. 1 represents an exploded representation of an electric machine, here in the form of an electric motor, for example for an electric vehicle. The individual components of the electric machine 6 shall not be discussed any further at this point. However, a rotor 30, which is mounted on a shaft 32, is denoted. The rotor 30 comprises a laminated core 4, which is represented in more detail in FIG. 2, with the laminated core 4 being composed of individual stacked magnetic sheets. When installed in the rotor 30 the laminated core 4 is surrounded by windings (not represented here).

FIG. 3 represents a plan view of a magnetic sheet 2 which has two areas: a radially inner area 12 and a radially outer area 14. The radially inner area 12 comprises a first material component 8 and the radially outer area 14 comprises a second material component 10.

The first material component 8 constitutes a high supporting strength for the magnetic sheet 2. For example, high-alloy steels based on chromium-nickel may be used for this. The first material component 8 may be a chromium-nickel alloy which has, for example, 25% by weight chromium and a nickel content of 7% by weight. An alloy of this kind is a stainless steel alloy with a very high strength. The first material component 8, which forms the radially inner area 12 of the magnetic sheet 2, is responsible, in particular as a supporting structure, for the strength of the magnetic sheet 2, in particular at high rotational speeds. In contrast, the second material component 10 is embodied as a magnetic material component, in particular as a soft-magnetic component. It has a very high iron content e.g. above 95% by weight, or above 99% by weight. Such a high iron content results in a ferritic material structure which has particularly good soft-magnetic properties. A pure iron structure, for example, may have its magnetization reversed very easily, with the hysteresis losses during reversal of magnetization of the material being very low.

Production of a magnetic sheet 2 of this kind may be represented particularly well by a stencil printing method or screen printing method. The screen printing method is a sub-type of the stencil printing method, with a stencil being placed onto a substrate and a printing paste being printed onto the substrate through the open areas of the stencil by means of a doctor blade. With screen printing methods, the open areas of the stencil are embodied by a fine screen, whereby notable rheological effects are achieved.

With screen printing, the described areas, namely the radially inner area 12 and the radially outer area 14, are printed one after the other using different printing pastes. The first printing paste, which comprises the inner area 12 or the first material component 8, has material particles which, after the sintering process, become the first material component 8. That is to say, apart from organic binders, this first printing paste also has metal particles as functional component parts which include the material composition and the alloy elements of the first material component. In contrast, apart from the organic binders, the second printing paste, which reproduces the subsequent, second material component 10, has metal particles made from alloy elements of the second material component 10.

To produce the magnetic sheet 2, firstly, for example, the first printing paste is accordingly printed for the inner area 12. The substrate with the printing paste is preferably briefly dried and the outer area 14 is printed in a second printing step using a different stencil, which leaves out the outer area 14 of the magnetic sheet 2. The preliminary stage of the outer area 14 is thus printed. This is followed by a further drying step through to a green body and, optionally integrated in a process step, a debinding step. Organic binders and printing aids are thermally decomposed from the printed printing paste. After debinding, a resultant brown body substantially only still has the functionally acting material particles of the respective material component. A sintering step subsequently follows in which the brown body is sintered to form the magnetic sheet 2. Sintering is a heat treatment process in which adjoining particles assume a monolithic connection due to diffusion processes. Melting phases can occur locally although these are not dominant. The temperature during a sintering process of metallic materials like the magnetic sheet in the present case is, as a rule, between 900° C. and 1,400° C.

The magnetic sheet 2 produced in this way is optionally refinished and stacked on the laminated core as FIG. 2, for example, represents. The magnetic sheets 2 in the laminated core 4 in FIG. 2 do not have any different areas of material, as is described in FIG. 3. FIG. 2 therefore serves solely to illustrate a laminated core 4 per se. Apart from the advantages which the different material components have, the magnetic sheet 2 of FIG. 3 also has the advantage that, with a thickness of about 80 μm to 200 μm, it can be embodied to be thinner than conventional magnetic sheets punched from larger sheets. Thinner magnetic sheets are in turn more advantageous for the magnetic properties and thus for the power density of the electric machine.

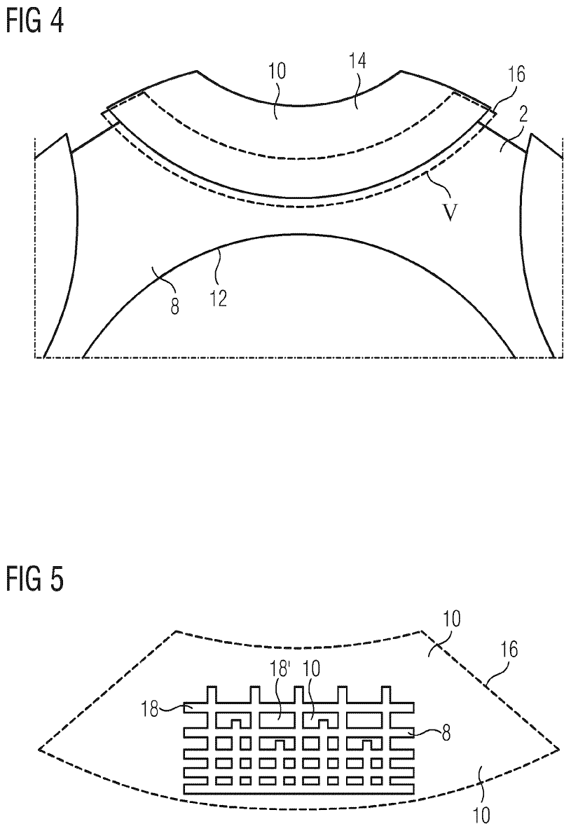

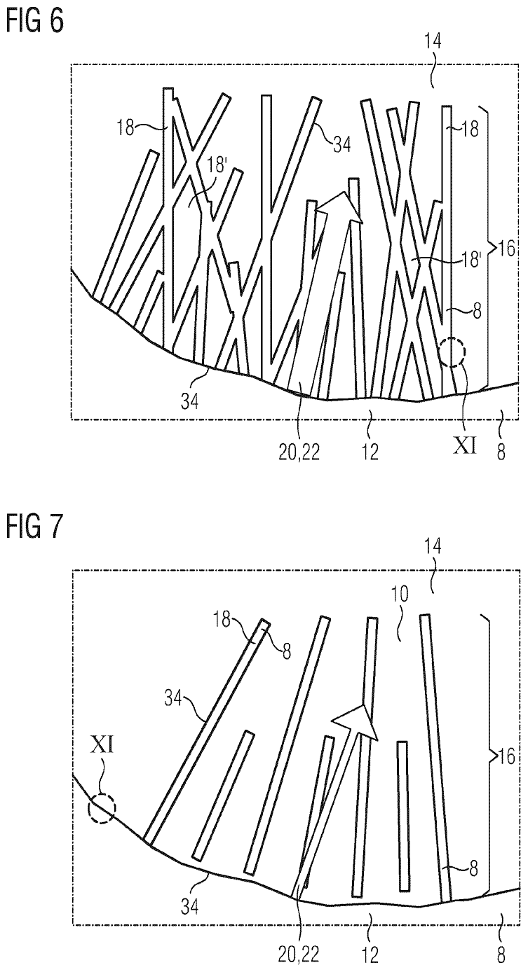

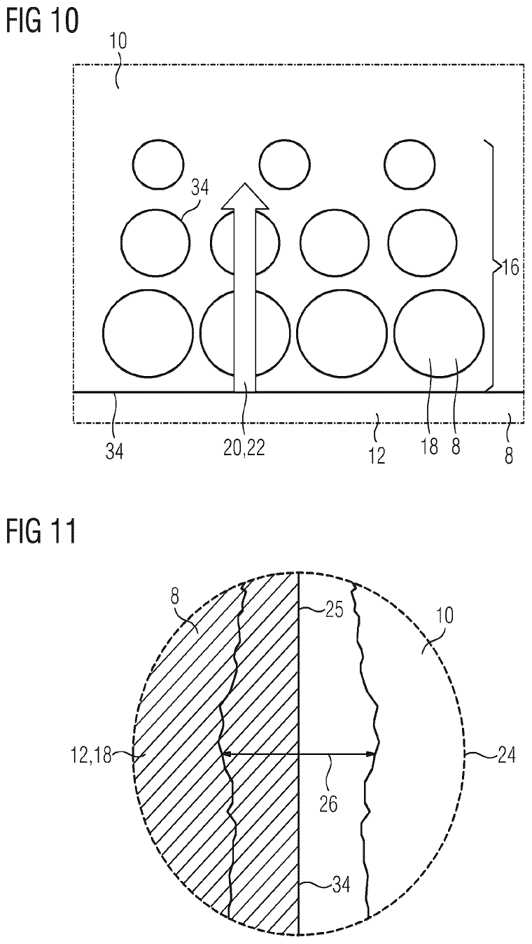

FIG. 4 is an enlarged representation of the magnetic sheet 2 in its outer area. A transition area 16 has been drawn in broken lines here. The transition area 16 represents the transition between the first material component 8 and the second material component 10. This is enlarged once again in FIG. 5, with a representation of discrete sub-areas 18 and 18′ respectively being drawn by way of example in FIG. 5, the effect of which sub-areas will be discussed in more detail in respect of FIGS. 6 to 10.

The transition area 16 is the area in which both the first material component 8 and the second material component 10 occur and, more precisely, not so that the two material components 8, 10 are present in mixed form but so that discrete sub-areas 18 are provided which in turn form a largely discrete material boundary 25 with the respective other material components (cf. FIG. 11).

Arrows with reference numeral 20 are drawn in FIGS. 6 to 10 and point in a radial direction, i.e. follow any radius of the magnetic sheet 2 and form a line 22 in the process. If the arrow 20 is followed from the inner area 12 into the outer area 14, then the line 22 cuts at least two discrete areas 18. This means that along the transition area 16 there are multiple changes between the first material component and the second material component in the form of the discrete areas 18, 18′. In this way a stress, caused owing to different thermal coefficients of expansion, is reduced. An entire boundary line 34 between the first material component 8 and the second material component 10 is raised as a whole in this way and it leads in a large number of different directions, so stresses that occur can be reciprocally canceled.

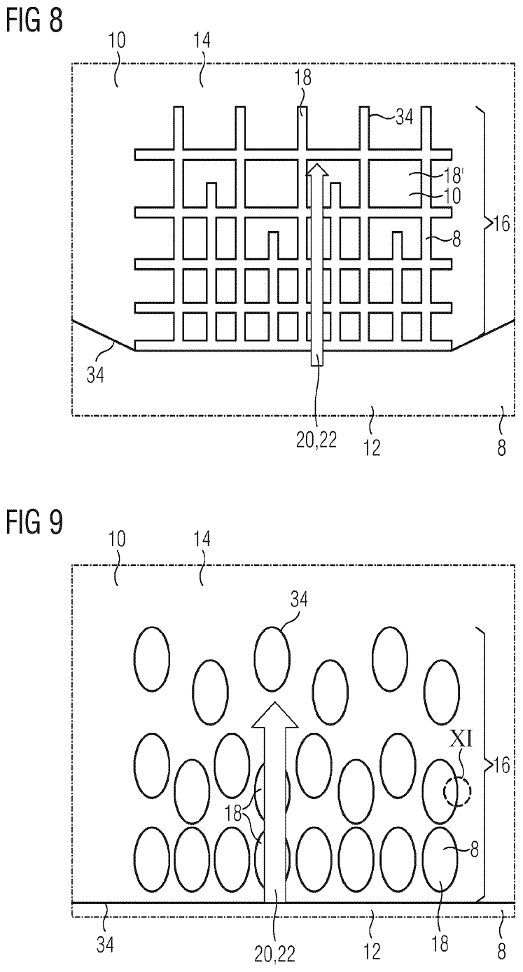

In some embodiments, discrete areas 18 of a material component 8, 10 are reciprocally surrounded by discrete areas 18′ of the respective other material component 8, 10, as is represented, for example, in FIGS. 6 and 8. This is depicted in these figures in the form of fence-like structures of the discrete areas 18, 18′. For example, in FIG. 8 the discrete areas 18 of the first material component 8 have an elongated, rod-shaped design and the discrete areas 18′, which are formed by the second material component 10, are in the form of right-angled areas with a low aspect ratio. Discrete areas 18 with enclosures of discrete areas 18′ are also represented in FIG. 6, with these being less right-angled embodiments than is the case in FIG. 8.

The discrete areas 18 and 18′, which are described in the last paragraph, can also be embodied to be complementary in respect of the first material component 8 and the second material component 10. The discrete areas 18 with the respective material components 8, 10, as are present in the inner area 12 or outer area 14, can be directly connected, as is represented, for example, in FIGS. 6 and 8, or they can be present so as to be spaced apart from them respectively, as is represented, for example, in FIGS. 9, 10 and 7. A hybrid form is depicted in FIG. 7: some discrete areas 18 are directly adjacent to the respectively corresponding area and grow out of them, others are completely separate from them.

It may be expedient to calculate the shape, surface area and size of the discrete areas 18, 18′ by means of a finite element method, so a minimal stress occurs with the resulting thermal coefficients of expansion. Depending on the diameter of the magnetic sheet 2, the transition area 16 is between 1 mm and 30 mm, or between 3 mm and 10 mm, wide. The difference in the coefficients of expansion can be most effectively compensated in a transition area of this width, which goes beyond a microscopic fine structuring. In some embodiments, the surface proportion of the first material component is <50% or between 5% and 40% in the transition area 16. This may be advantageous with regard to the magnetic properties of the outer area 14, that, in particular, the surface proportion of the non-soft-magnetic first material component is not too large. With regard to good soft-magnetic properties, but also with regard to a minimization of the thermal stresses, this proportion should lie within the described ranges.

When the term of the discrete material boundary 25 is introduced, this term is prefixed by the term “largely”. This means that the material boundary 25 in the macroscopic sense is completely discrete with regard to the width of the transition area 16; in a microscopic observation it has a diffusion zone 26, however, as is represented in enlarged form in FIG. 12. FIG. 11 is an enlarged representation of the detail XI, while FIGS. 6, 7 and 9 are merely schematic representations of this detail XI. This is illustrative of the entire boundary area 24 between the first material component 8 and the second material component 10 along the boundary line 34. FIG. 11 represents said boundary area 24, with the second material component 10 running on the right-hand side and the first material component 8 being arranged on the left-hand side. The diffusion zone 26, which conventionally has an extent which is >50 μm, is situated between the two material components 8, 10. While ions basically diffuse from one material area into the other, and vice versa, in a conventional boundary area between two materials, attempts are conventionally made to keep this effect as minimal as possible by way of process engineering measures. Contrary to the customary diffusion zones, the diffusion zone 26 in FIG. 11 is much wider in design, and this can be achieved by a respectively higher temperature or duration of the sintering process. In order to bring this about, for example, an increase in temperature by 50 K to 100 K and/or a lengthening of the dwell time at the maximum sintering temperature by 30 min up to two hours with respect to a temperature or time that is actually necessary for frittage can be expedient. A diffusion zone, which is broadened in this way, between the material components likewise contributes to the reduction in instances of stress which are induced by the different thermal coefficients of expansion.

### LIST OF REFERENCE NUMERALS

2 magnetic sheet
4 laminated core
6 electric machine
8 first material component
10 second material component
12 radially inner area
14 radially outer area
16 transition area
18 discrete sub-area
20 radial direction
22 line
24 boundary area
25 material boundary
26 diffusion zone
28 radial extension
30 rotor
32 shaft
34 boundary line

What is claimed is:

1. An additively produced magnetic sheet for a laminated core of an electric machine, the sheet comprising:
a first material component arranged in a radially inner area of the magnetic sheet;
a second material component arranged in a radially outer area; and
a transition area between the radially inner area and the radially outer area, wherein the transition area includes both the first material component and the second material component in discrete sub-areas;
where in the discrete sub-areas are arranged in a row in the radial direction such that a line following a radius cuts at least two discrete sub-areas.

2. The magnetic sheet as claimed in claim 1, further comprising a diffusion zone in a boundary area between the first material component and the second material component in the transition area extending by at least 50 μm into each material component.

3. The magnetic sheet as claimed in claim 1, wherein in the transition area has a surface proportion of the first material component between 5% and 40%.

4. The magnetic sheet as claimed in claim 1, wherein the transition area has a radial extension between 1 mm and 30 mm.

5. The magnetic sheet as claimed in claim 1, wherein the discrete areas have a maximum extension between 0.5 mm and 10 mm.

6. The magnetic sheet as claimed in claim 5, wherein the transition area has a radial extension between 3 mm and 10 mm.

7. The magnetic sheet as claimed in claim 1, further comprising a plurality of discrete sub-areas of at least one material component intersecting in such a way that at least one discrete sub-area of the respective other material component is enclosed.

8. The magnetic sheet as claimed in claim 1, wherein the first material component comprises an iron alloy with at least 25% by volume of an austenitic structure.

9. The magnetic sheet as claimed in claim 1, wherein the second material component comprises an iron alloy with at least 95% by weight iron.

10. The magnetic sheet as claimed in 9, wherein the second material component has a ferritic or martensitic structure.

11. The magnetic sheet as claimed in claim 1, wherein the first material component comprises a chromium-nickel alloy.

12. The magnetic sheet as claimed in claim 11, wherein the first material component comprises an iron-chromium alloy with a chromium content between 22% by weight and 28% by weight.

13. The magnetic sheet as claimed in claim 9, wherein the first material component has a nickel content between 4% by weight and 10% by weight.

14. A laminated core for a rotor of an electric machine, the laminated core comprising a plurality of magnetic sheets, each sheet comprising:
a first material component arranged in a radially inner area of the magnetic sheet;
a second material component arranged in a radially outer area; and
a transition area between the radially inner area and the radially outer area, wherein the transition area includes both the first material component and the second material component in discrete sub-areas;
wherein the discrete sub-areas are arranged in a row in the radial direction such that a line following a radius cuts at least two discrete sub-areas.

15. An electric machine comprising:
a laminated core comprising a plurality of magnetic sheets, each sheet comprising:
a first material component arranged in a radially inner area of the magnetic sheet;
a second material component arranged in a radially outer area; and
a transition area between the radially inner area and the radially outer area, wherein the transition area includes both the first material component and the second material component in discrete sub-areas;
wherein the discrete sub-areas are arranged in a row in the radial direction such that a line following a radius cuts at least two discrete sub-areas.
